(19) United States
(12) Patent Application Publication
(10) Pub. No.: US 2013/0342305 A1
(43) Pub. Date: Dec. 26, 2013

(54) STRUCTURE OF POSITIONING COVER OF MINIATURE FUSE DEVICE

(71) Applicant: JUI-CHIH YEN, Taipei City (TW)

(72) Inventor: JUI-CHIH YEN, Taipei City (TW)

(21) Appl. No.: 13/532,751

(22) Filed: Jun. 25, 2012

(51) Int. Cl. H01H 85/02

(52) U.S. Cl. 337/187

(57) ABSTRACT

The invention is directed to a structure of positioning a cover of a miniature fuse device, characterized in that locking bumps are set at two sides of the body of the miniature fuse device and locking holes are set at two sides of the cover. When the body is received in the cover, the locking bumps of the body fix with the locking holes at the cover such that the cover can firmly join the body. Accordingly, the cover can be prevented from falling off due to improper external forces when the miniature fuse device is being transferred or stored.

### BACKGROUND OF THE DISCLOSURE

a) Field of the Disclosure

The invention relates to an improvement of a miniature fuse device used in an electronic industry such that the improved miniature fuse device can be provided with a cover free from dropping off.

b) Brief Description of the Related Art

A miniature fuse device in accordance with the present invention is used in an electronic industry and has a round or rectangle shape. FIGS. 1 and 2 show a traditional miniature fuse device having a round shape. Referring to FIGS. 1 and 2, the miniature fuse device is mainly composed of a body 10 and a cover 20. Two wires 40 at a bottom of the body 10 extend upwards to form leads 41 at a top of the body 10 for connecting with a fuse 30. A protruding rim 101 is set at a periphery of the body 10. Explosion-proof sand is filled into the top of the body 10 of the miniature fuse device after joined with the cover 20 so as to prevent excessive explosion created when the fuse 30 is broken due to overheating. When the cover 20 covers the body 10, the protruding rim 101 at the periphery of the body 10 leads the body 10 to tightly join the cover 20. However, this joint seems firm but not in practice. When the miniature fuse device having the cover 20 tightly joining the body 10 is being transferred or stored, the cover 20 could be loosen or fall off due to vibration or improper external forces such that the explosion-proof sand is scattered. Even though the cover 20 can join the body 10 again, the miniature fuse device cannot be used. Accordingly, the miniature fuse device is not an ideal structure and should be improved.

### SUMMARY OF THE DISCLOSURE

The present invention provides a main objective to solve the current miniature fuse device having the deficient joint, between the cover and the body, leading the cover to fall off and the fuse device to be broken.

The invention is directed to a structure of positioning a cover of a miniature fuse device, having a rectangle shape, mainly composed of a body and a cover. Two wires at a bottom of the body extend upwards to form leads at a top of the body to be connected with a fuse. The invention provides an improvement that locking bumps are set at two sides of the body of the miniature fuse device and locking holes are set at two sides of the cover. When the body is received in the cover, the locking bumps of the body fix with the locking holes at the cover such that the cover can firmly join the body. Accordingly, the cover can be prevented from falling off due to improper external forces when the miniature fuse device is being transferred or stored.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematic view of a general miniature fuse device.

FIG. 2 is a cross-sectional view of a general miniature fuse device.

FIG. 3 is an exploded view of a miniature fuse device in accordance with the present invention.

FIG. 4 is an appearance view of a miniature fuse device in accordance with the present invention.

FIG. 5 is a cross-sectional view of a miniature fuse device in accordance with the present invention.

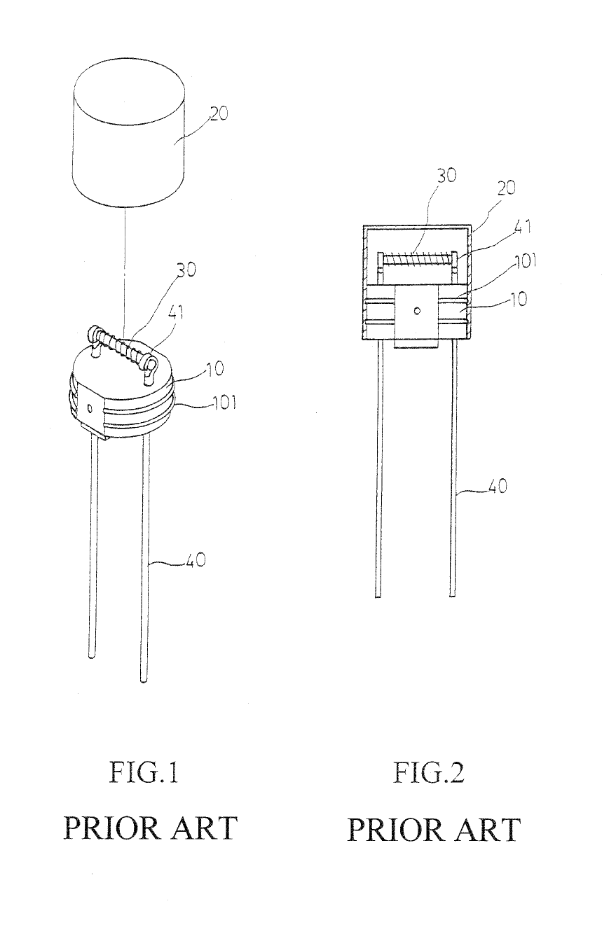

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

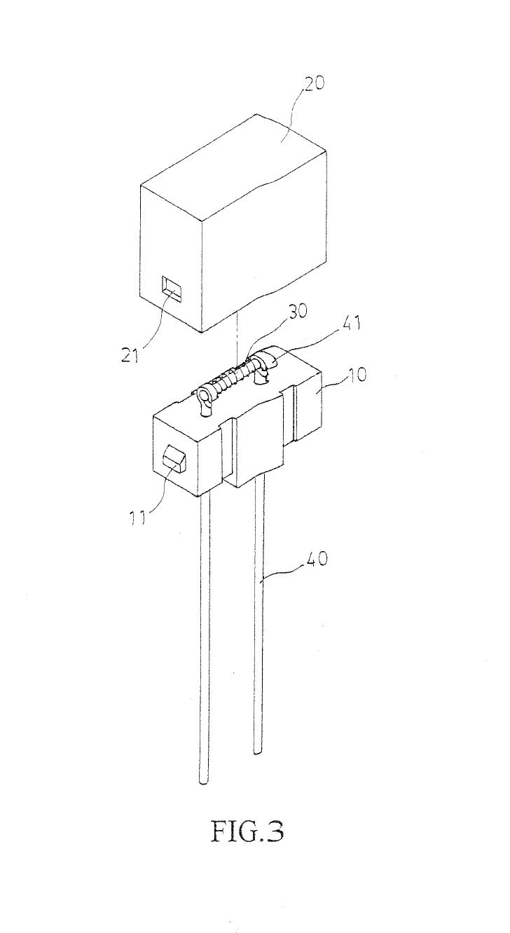

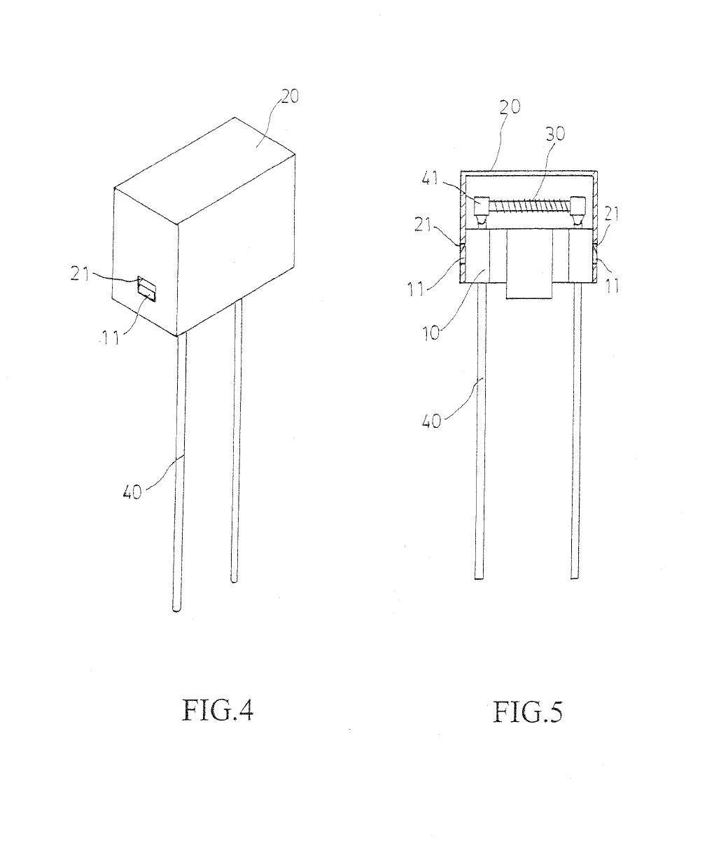

Referring to FIGS. 3-5, the invention is directed to a structure of positioning a cover of a miniature fuse device, having a rectangle shape, mainly composed of a body 10 and a cover 20. Two wires 40 at a bottom of the body 10 extend upwards to form leads 41 at a top of the body 10 to be connected with a fuse 30. Locking bumps 11 having most protruded portions at bottoms thereof and inclined surfaces are set at two sides of the body 10 and locking holes 21 are set at two sides of the cover 20. After an appropriate amount of explosion-proof sand is filled into the cover 20, the cover 20 joins the body 10 and the locking bumps 11 of the body 10 fix with the locking holes 21 at the cover 20 such that the cover 20 can firmly join the body 10. Accordingly, the cover 20 can be prevented from falling off due to improper external forces when the miniature fuse device is being transferred or stored.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A structure of positioning a cover of a miniature fuse device mainly composed of a body and a cover, wherein two wires at a bottom of the body extend upwards to form leads at a top of the body to be connected with a fuse, characterized in that:
locking bumps are set at two sides of the body of the miniature fuse device, locking holes are set at two sides of the cover, and the locking bumps of the body fix with the locking holes at the cover when the body is received in the cover.

2. The structure of claim 1, wherein the locking bumps have most protruded portions at bottoms thereof and inclined surfaces.
